(19) United States
(12) Patent Application Publication
(10) Pub. No.: US 2025/0030651 A1
(43) Pub. Date: Jan. 23, 2025

(54) INFORMATION PROCESSING METHOD, APPARATUS, ELECTRONIC DEVICE AND STORAGE MEDIUM

(71) Applicant: Beijing Zitiao Network Technology Co., Ltd., Beijing (CN)

(72) Inventors: Xinru ZHANG, Beijing (CN); Shi Qiu, Beijing (CN); Wenbin Zhang, Beijing (CN); Haibo Liu, Beijing (CN); Li Chen, Beijing (CN)

(21) Appl. No.: 18/905,087

(22) Filed: Oct. 2, 2024

Related U.S. Application Data
(63) Continuation of application No. PCT/CN2023/084975, filed on Mar. 30, 2023.

(30) Foreign Application Priority Data
Apr. 2, 2022 (CN) 202210351954.1

(51) Int. Cl. H04L 51/02; G06F 3/0482; G06F 3/0484

(52) U.S. Cl. CPC H04L 51/02; G06F 3/0484; G06F 3/0482

(57) ABSTRACT

The present disclosure provides an information processing method, apparatus, electronic device and storage medium. An information processing method comprises: in response to inputting first item information by a first user, storing the first item information in a first system and determining a first topic group based on the first item information; and generating first topic information based on the first item information, and sending the first topic information to the first topic group; wherein the first topic information is associated with the first item information. The present disclosure realizes aggregated display of information and facilitates message aggregation and processing by processing personnel.

### CROSS REFERENCE TO RELATED APPLICATION(S)

This application is a continuation of International Patent Application No. PCT/CN2023/084975, filed on Mar. 30, 2023, which claims the benefit of CN patent application No. 202210351954.1, filed on Apr. 2, 2022, both of which are incorporated herein by reference in their entireties.

### FIELD

The present disclosure relates to a field of information processing, and in particular, to an information processing method, apparatus, electronic device and storage medium.

### BACKGROUND

In various scenarios such as production and work within an enterprise, item information needs to be input. The inputted item information is stored in a storage system, and relevant personnel may view and process the item information in the storage system.

### SUMMARY

The present disclosure provides an information processing method, apparatus, electronic device and storage medium.

The present disclosure employs the following technical solutions.

In some embodiments, the present disclosure provides an information processing method, comprising: in response to inputting first item information by a first user, storing the first item information in a first system and determining a first topic group based on the first item information; and generating first topic information based on the first item information, and sending the first topic information to the first topic group; wherein the first topic information is associated with the first item information.

In some embodiments, the present disclosure provides an information processing apparatus, comprising: a determining unit configured to, in response to inputting first item information by a first user, store the first item information in a first system and determine a first topic group based on the first item information; and a sending unit configured to generate first topic information based on the first item information, and send the first topic information to the first topic group; wherein the first topic information is associated with the first item information.

In some embodiments, the present disclosure provides an electronic device, comprising: at least one memory and at least one processor; wherein the memory is configured to store program code, and the processor is configured to call the program code stored in the memory to execute the above-mentioned method.

In some embodiments, the present disclosure provides a computer-readable storage medium, wherein the computer-readable storage medium is configured to store program code, when run by a processor, the program code causes the processor to execute the above-mentioned method.

In the methods proposed in some embodiments of this disclosure, after determining that the first item information is input, the first item information is stored and sent to the first topic group, and an association between the first topic information and the first item information is established, so that personnel related to the first topic information may discuss and process the first item information in the first topic group. And since it is published in the first topic group, the first topic information published is of the topic format; for the first topic information, its reply information and other related information will be automatically aggregated under the topic of the first topic information, so as to realize aggregated display of information and facilitate message aggregation and processing by processing personnel.

### BRIEF DESCRIPTION OF THE DRAWINGS

The above and other features, advantages and aspects of various embodiments of the present disclosure will become more apparent with reference to the following embodiments in conjunction with the accompanying drawings. Throughout the drawings, the same or similar reference numbers refer to the same or similar elements. It is to be understood that the drawings are schematic and that components and elements are not necessarily drawn to scale.

FIG. 1 is a flow chart of an information processing method of an embodiment of the present disclosure.

FIG. 2 is a schematic diagram of an input interface for first item information of an embodiment of the present disclosure.

FIG. 3 is a schematic diagram of a first topic group of an embodiment of an embodiment of the present disclosure.

FIG. 4 is a schematic diagram of an input interface for first item information of an embodiment of the present disclosure.

FIG. 5 is a schematic diagram of an input interface for first item information of an embodiment of the present disclosure.

FIG. 6 is a schematic diagram of a first topic group and a first item information details page in a first system of an embodiment of the present disclosure.

FIG. 7 is a schematic diagram of a first topic group and a first object details page in a first system of an embodiment of the present disclosure.

FIG. 8 is a schematic diagram of a first document of an embodiment of the present disclosure.

FIG. 9 is a schematic diagram of a request page of an embodiment of the present disclosure.

FIG. 10 is a schematic diagram of a first topic group of an embodiment of the present disclosure.

FIG. 11 is a schematic diagram of a first topic group of an embodiment of the present disclosure.

FIG. 12 is a schematic diagram of a first topic group of an embodiment of the present disclosure.

FIG. 13 is a schematic structural diagram of an electronic device of an embodiment of the present disclosure.

### DETAILED DESCRIPTION

Embodiments of the present disclosure will be described in more detail below with reference to the accompanying drawings. Although certain embodiments of the disclosure are shown in the drawings, it should be understood that the present disclosure may be implemented in various forms and should not be construed as limited to the embodiments set forth herein, but rather these embodiments are provided for thoroughly and fully understand the present disclosure. It should be understood that the drawings and embodiments of the present disclosure are provided for illustrative purposes only but not intended to limit the scope of the present disclosure.

It should be understood that various steps described in the method implementations of the present disclosure may be executed in different orders and/or in parallel. Furthermore, the method implementations may include additional steps and/or the illustrated steps may be omitted. The scope of the present disclosure is not limited in this regard.

The term “including” and its variations as used herein are non-exclusive inclusion, i.e. “including but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concepts of “first” and “second” mentioned in this disclosure are only used to distinguish different apparatuses, modules, or units, but are not used to limit the order or interdependence of the functions performed by these apparatuses, modules, or units.

It should be noted that the modifications of “one” and “a plurality of” mentioned in this disclosure are illustrative but not limiting. Those skilled in the art should understand that unless otherwise indicated in the context, they should be understood as “one or more”.

The names of the messages or information interacted between a plurality of apparatuses in this public implementation are for illustrative purposes only, which are not intended to limit the scope of these messages or information.

The solution provided by embodiments of this application will be described in detail below with reference to the accompanying drawings.

In scenarios such as production scenarios and work scenarios, item information is often generated. The item information can be demands or tasks, for example. The item information is usually stored in a specific system, and then relevant personnel view the stored item information in the specific system. For personnel who process the item information, they may need to discuss about the item information. During the discussion, messages are scattered and are not easy to be gathered.

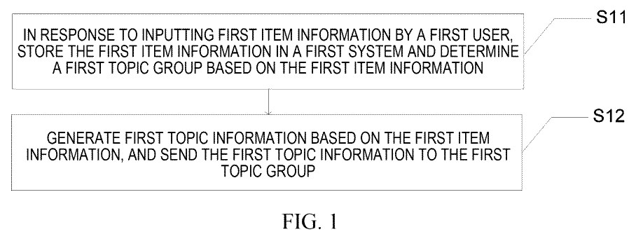

As shown in FIG. 1, FIG. 1 is a flow chart of an information processing method of an embodiment of the present disclosure. The method includes the following steps.

S11: in response to inputting first item information by a first user, storing the first item information in a first system and determining a first topic group based on the first item information.

S12: generating first topic information based on the first item information, and sending the first topic information to the first topic group.

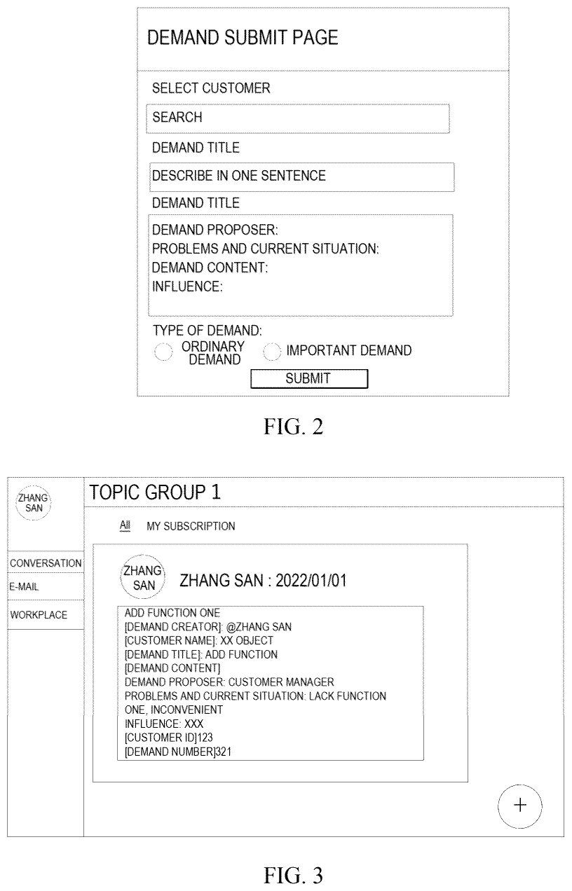

In some embodiments, an interface for inputting the first item information may not be a message input interface for the first topic group. It may be an input interface for the item information in the first system, or it may be a certain applet interface, for example, the first item information may be inputted to an applet entrance associated with the first system. In some embodiments, FIG. 2 shows a schematic input interface for the first item information. The information processing method can be applied on an instant messaging client, and the first item information may be inputted to an applet at the instant messaging client, or the first item information can be inputted in the web page, which is not limited herein. The first item information may be task information or demand information. The first system may be a first server. The first item information is stored in the first system and the first topic group is determined. The first topic group is a topic group. Messages in the topic group are displayed in a form of topic information or reply information to the topic information. Users may subscribe to the topic information in the topic group so as to only view the subscribed topic information. As shown in FIG. 3, after the first topic group is determined, the first item information is carried as the first topic information. The first item information can be displayed in the first topic information, and the first topic information is sent and displayed in the first topic group (topic group 1 in FIG. 3). The topic information of Zhang San in FIG. 3 is the first topic information. The topic information is different from general instant messaging messages. As shown in FIG. 3, the topic information and the reply information to the topic information are aggregated in one topic card so that users can easily view all the content of the topic information. The topic card may be displayed with controls such as likes, replies, forwards, subscriptions, etc., so that the topic information can be operated. For topic groups, the way of publishing topic information can also be different from that in ordinary instant messaging groups. As shown in FIG. 3, by triggering a control in the lower right corner of FIG. 3 (a circle with a plus sign inside) to pop up the topic publishing interface, topic title, topic content and other information may be written into the topic publishing interface, to complete the publication of the topic information. In this embodiment, the first topic information is associated with the first item information.

In some embodiments of this disclosure, after determining that the first item information is input, the first item information is automatically stored and sent to the first topic group, and an association between the first topic information and the first item information is established, so that personnel related to the first topic information may discuss and process the first item information in the first topic group. And since it is published in the first topic group, the published information is the first topic information in the topic format; for the first topic information, its reply information and other related information will be automatically aggregated under the topic of the first topic information, so as to realize aggregated display of information and facilitate message aggregation and processing by processing personnel.

In some embodiments of the present disclosure, the method further includes: in response to a first operation event for the first topic information in the first topic group, synchronizing a processing result of the first operation event to the first item information in the first system. In some embodiments, the first operation event may be, for example, a processing event for the first topic information, such as an operation of marking the first topic information in the first topic group as being solved. According to the first operation event for the first topic information, processing may be performed in the first topic group, and the processing result may be synchronized to the first item information in the first system, so that the user can directly process the first item in the first topic group without entering the first system, which is convenient for users.

In some embodiments, the method further includes: in response to a second operation event for the first item information in the first system, synchronizing a processing result of the second operation event to the first topic information in the first topic group. In some embodiments, the second operation event may be, for example, an operation of marking the first item information as important, or marking it as being solved, etc. In response to the second operation event, the first item information will be processed in the first system, and then the processing result will be synchronized back to the first topic information in the first topic group, thereby the first item information in the first system is in consistent with the first item information carried by the first topic information in a first topic area, avoiding inconvenience to processing personnel due to inconsistency between the two.

In some embodiments of the present disclosure, determining the first topic group based on the first item information includes: in response to the first item information including a selected topic group, taking the selected topic group as the first topic group; or in response to the first item information including group creation information, creating the first topic group based on the group creation information. In some embodiments, after inputting the first item information, an existing topic group may be selected and the first topic information may be published in the selected topic group, or the user may designate to create a new topic group when inputting the first item information, thereby publishing first topic information to the new topic group. In some embodiments, a default topic group can be set, and the default topic group is used as the default selected topic group. In some embodiments, the group creation information includes designated members, and the designated members are added to the created first topic group.

In some embodiments of the present disclosure, the information processing method further includes: the first item information including a first object, and associating the first item information with the first object in the first system. In some embodiments, the first item information may be the first item information related to the first object. For example, the first object may be a certain enterprise, department or a certain user, and the first item information may be demand information of the enterprise, department or user, so that the first object is relevant to the first item information, and the first object needs to be associated with the first item information. In some embodiments, the first item information after being associated with the first object can be viewed on the page of the first object of the first system, or a control for jumping to the first item information or the first topic information may be provided. In some embodiments, the first object can be displayed in the first topic information associated with the first item information, and the page of the first object in the first system is opened after the first object in the first topic information is triggered.

In some embodiments of the present disclosure, an input interface for the first item information has a first control for selecting a category of the first item information; and the first control is configured to determine whether the first item information is of a first category or a second category. In some embodiments, the first category and the second category can be used to identify the importance level of the first item information. For example, the item information can be divided into important and ordinary. Taking the item information as a demand item as an example, as shown in FIG. 2, category selection controls corresponding to ordinary demand and important demand are displayed in the input interface for the first item, and the first category or second category is added in the first item information through the category selection controls. The importance level of the first category can be lower than that of the second category. The first category may represent ordinary, and the second category can may represent important.

In some embodiments of the present disclosure, the information processing method includes: in response to the first item information being of the first category, storing the first item information in the first system and determining the first topic group based on the first item information; and generating the first topic information based on the first item information and sending the first topic information to the first topic group; in response to the first item information being of the second category, storing the first item information in the first system and determining a first communication group based on the first item information; and generating first communication information based on the first item information and sending the first communication information to the first communication group, the first communication group being a non-topic group.

In some embodiments, the importance level of the first category is lower than that of the second category. The differences between the topic group and the non-topic group include: when members of the topic group can subscribe to topic information, the topic information that a user participates in or publishes is subscribed by default; when the topic information to which the user subscribes is updated, notification messages can be received; when the topic information to which the user has not subscribed is updated, no notification message is sent to the user. Only after entering the topic group, the user may view updates of the unsubscribed topic information; whereas, in non-topic groups, when messages are generated in non-topic groups, users will receive notification messages. It can be seen that in topic groups, accurate message notifications can be achieved, but the message notification intensity is weak; whereas, the notification intensity in non-topic groups is stronger, but the message notifications are not accurate enough. Therefore, when the first item information is of the first category, users usually only cares about changes of the first topic information and they do not care about the information published by other people that has nothing to do with the first topic information, therefore, the first item information is published to the first topic group in the form of the first topic information. When the first item information is of the second category, since the second category is more important, the user is more concerned about any related information, so the first item information is sent to a non-topic group with higher message notification intensity in the form of the first communication information. In this embodiments, item information of different categories is published to different groups to adapt to the intensity of message notifications that need to be implemented.

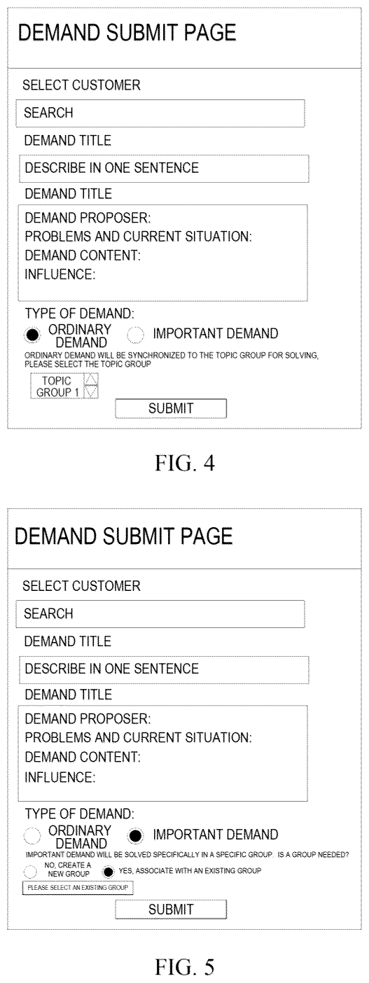

In some embodiments of the present disclosure, determining the first topic group based on the first item information includes: in response to the first item information being determined to be of the first category based on the first control, displaying at least one topic group to be selected, and in response to a selection on the at least one topic group displayed, determining a selected topic group as the first topic group. In some embodiments, please refer to FIG. 4, if the first category “General Demands” is selected when inputting the first item information, a control for selecting an associated topic group will be displayed (the associated topic group selected is the topic group 1 in FIG. 4), the selected topic group can be switched and the selected topic group is taken as the first topic group.

In some embodiments of the present disclosure, determining the first communication group based on the first item information includes: in response to the first item information being determined to be of the second category based on the first control, displaying a second control for creating a communication group and a selection control for selecting an existing communication group, and in response to the second control being triggered, generating communication group creation information and creating the first communication group, or in response to a selected communication group after the selection control being triggered, taking the selected communication group as the first communication group. In some embodiments, as shown in FIG. 5, when the second category “Important Demand” is selected as inputting the first item information, two options are displayed, one is an option to create a new group, and the other is an option to associate an existing group. If the option to create a new group is selected, some relevant information required to create a group may be input, such as group name, group members, etc. If the option to associate an existing group is selected, the existing group is needed to be selected.

In some embodiments of the present disclosure, determining the first topic group based on the first item information includes: in response to the first item information being determined to be of the first category based on the first control, displaying at least one topic group to be selected, and in response to a selection on the at least one topic group displayed, determining a selected topic group as the first topic group; or in response to the first item information being determined to be of the second category based on the first control, displaying a second control for creating a topic group and a selection control for selecting an existing topic group, and in response to the second control being triggered, generating topic group creation information and creating the first topic group, or in response to a selected topic group after the selection control being triggered, taking the selected topic group as the first topic group. In this embodiment, regardless of whether the first item information is of the first category or of the second category, the first topic information is published to the first topic group. The difference therebetween includes that when the first item information is of the first category, the first topic information is published only to the existing topic group, and when the first item information is of the second category, the first topic information cannot only be published to the existing topic group, but also a first topic group can be created in customized way to meet the users' individual needs.

In some embodiments of this disclosure, the first topic information includes at least one of the following determined based on the first item information: the first user, a department to which the first user belongs, a first object associated with the first item information, an identifier of the first object, a title of the first item information, an identifier of the first item information, or content of the first item information. In some embodiments, take the first item information being a demand item as an example, please refer to FIG. 3, the first user is user Zhang San who inputs the first topic information, the first item information is associated with the first object “XX object”, the identifier of the first object is customer ID “123”, and the identifier of the first item information is demand number “321”.

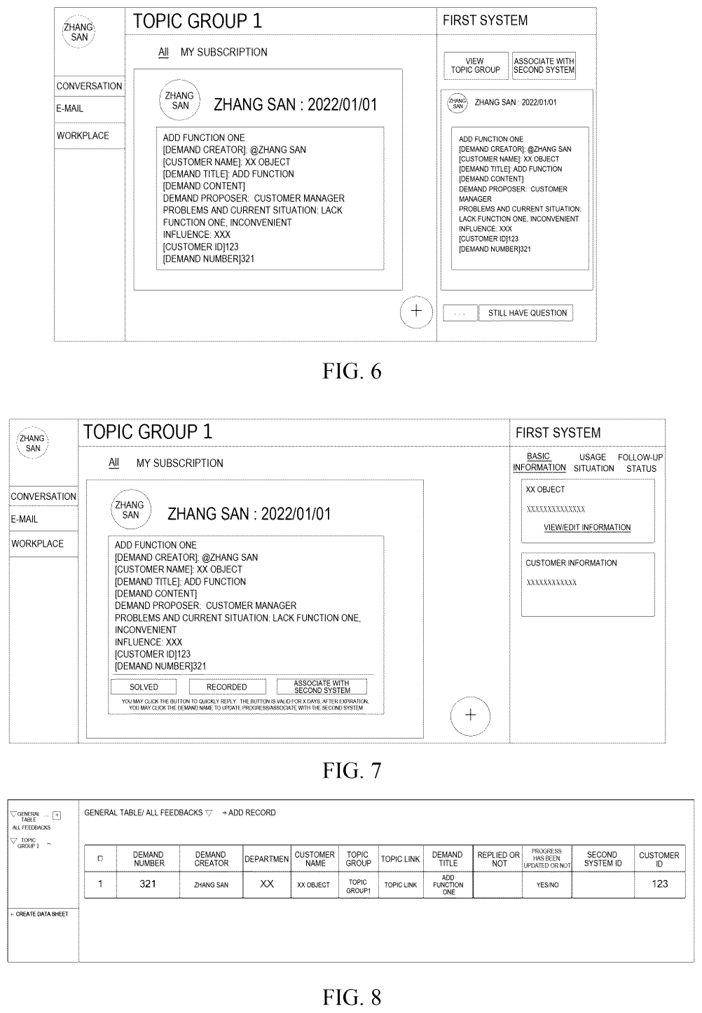

In some embodiments of the present disclosure, the method further includes: in response to the title of the first item information or the identifier of the first item information in the first topic information being triggered, opening a details page of the first item information in the first system. In some embodiments, please refer to FIG. 6, the first topic information is displayed with the title of the first item information (“Add Function” of the demand title in FIG. 6) and the identifier of the first topic information (demand number “321” in FIG. 6), the triggering operation may be a click operation, and through the triggering operation on the title of the first item information or the identifier of the first item information, the first item information input in the first system will be viewed, as shown in FIG. 6, the details page of the first item information in the first system may be displayed in the sidebar, or a pop-up window can be used to display the details page of the first item information, so that users may view related content in the first item information at any time when viewing the first topic information, which is convenient for users to process.

In some embodiments of the present disclosure, the method further includes: in response to the first object or the identifier of the first object in the first topic information being triggered, opening a details page of the first object in the first system. In some embodiments, please refer to FIG. 7, the first object (customer name “XX object” in FIG. 7) and the identifier of the first object (customer ID “123” in FIG. 7) are displayed in the first topic information. The triggering operation can be a click operation, by triggering the first object or the identifier of the first object, as shown in FIG. 7, the details page of the first object in the first system may be displayed in the sidebar, or a pop-up window can be used to display the details page of the first object. The first item information is related to the first object. Therefore, when processing the first topic information of the first item information, it is often necessary to view the related information of the first object. The embodiments of the present disclosure provide a quick access for viewing the first object, which enables users to conveniently view the information.

In some embodiments of the present disclosure, sending the first topic information to the first topic group includes at least one of the following: sending the first topic information in the first topic group by using an account of the first user; and mentioning the first user in the first topic information. In some embodiments, please refer to FIG. 3, after the first user “Zhang San” inputs the first item information, the first topic information will be automatically sent in the name of the first user “Zhang San”, which indicates the creator of the first topic information, without user operation. It should be noted that the first user will also be mentioned at this time, such as the first user “Zhang San” is mentioned by @ to remind the first user. Since the first topic information is sent in the name of the first user, the first user will not be reminded. In order to remind the first user, the first user will be automatically mentioned by @, thereby realizing the reminder and preventing the first user from not knowing in time that first topic information is published.

In some embodiments of the present disclosure, the information processing method further includes: generating, based on the first topic information, first record information in a first document, the first record information being associated with the first topic information. In some embodiments, the first document may be an online document, which may be a text document or a table document, such as a multidimensional table. After the first topic information is generated, as shown in FIG. 8, the first record information is generated according to the first topic information in the first document, and the first topic information is associated with the first record information. In some embodiments, the first topic information in the first topic group and the first record information in the first document are kept in synchronization. Modifications to the first topic information in the first topic group will be synchronized to the first record information in the first document. Similarly, modifications to the first record information in the first document will be synchronized to the first topic information in the first topic group. The modification may be described in the form of reply information to the first topic information, and the reply information may be replied to the first topic information, and the first topic information is recorded through the first record information in the first document, so that the user can conveniently check the topic status in the first document.

In some embodiments of the present disclosure, the method further includes: the first record information in the first document including an association identifier of the first topic information; in response to the association identifier of the first topic information in the first document being triggered, opening the first topic group and locating to the first topic information. In some embodiments, please continue to refer to FIG. 8, the association identifier of the first topic information can be the topic link in FIG. 8. Through the topic link, the first topic information may be directly jumped to, so as to facilitate viewing of relevant information, thereby reducing user searches. In some embodiments of the present disclosure, the method further includes: the first record information in the first document including an association identifier of the first topic group; in response to the association identifier of the first topic group in the first document being triggered, opening the first topic group. In some embodiments, the name or ID of the first topic group can be recorded in the first record information, and the first topic group can be opened by clicking or other methods.

In some embodiments of the present disclosure, the details page of the first item information in the first system is displayed with a third control, and the third control is configured to, after being triggered, locate to the first topic information in the first topic group. In some embodiments, as shown in FIG. 6, the third control “View Topic Group” is displayed on the details page of the first item information of the first system on the right side of FIG. 6. When the third control is triggered by clicking or other methods, the first topic information is located to, the details page of the first item information of the first system can be opened in a variety of ways. It can be opened in an applet or by accessing the webpage of the first system. It is not limited to be opened through the sidebar as shown in FIG. 6. If the first topic group is already opened when the third control is triggered, the currently displayed area of the first topic group can be directly adjusted to the location of the first topic information. If the first topic group is not opened when the third control is triggered, the first topic group will be opened and then the first topic information may be located to.

In some embodiments of the present disclosure, the details page of the first item information in the first system is displayed with a fourth control, and the fourth control is configured to, after being triggered, determine content in a second system and associate the content with the first item information. In some embodiments, as shown in FIG. 6, the details page of the first item information in the first system shown on the right side of FIG. 6 is displayed with a fourth control “Associate with second system”. When the fourth control is triggered by clicking or other methods, a pop-up window may be displayed, the address in the second system may be input through the pop-up window, and the content corresponding to the address is associated with the first item information, so that after associating the first item information with the content in the second system, when the first item information progresses, a notification can be sent to a page where the associated content in the second system is located, and an entrance to the first item information can be provided on the page of the associated content in the second system to facilitate mutual review.

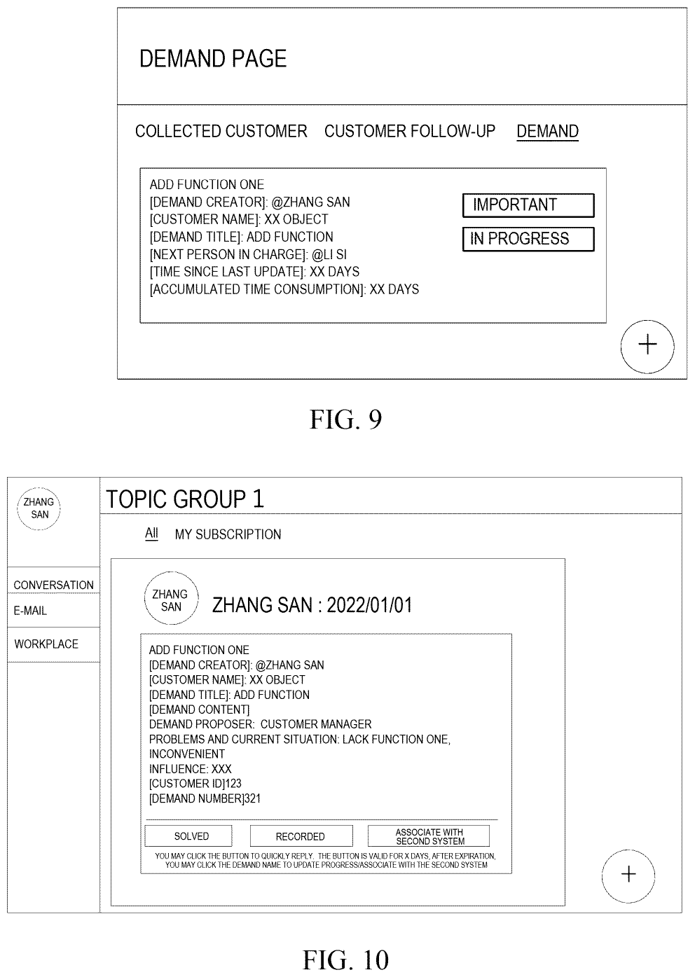

In some embodiments of the present disclosure, summary information of the first item information is displayed on a user page of the first user; the summary information includes at least one of the following: name of the first item information, first object associated with the first item information, and classification information and progress information of the first item information. In some embodiments, as shown in FIG. 9, the first item information and its summary information published are displayed in the demand page of the first user, making it easier for users to know the progress of the item information they proposed.

In some embodiments of the present disclosure, the first topic information is sent to the first topic group in a form of a topic card; at least one of a fifth control, a sixth control or a seventh control is displayed in the topic card of the first topic group; the fifth control is configured to, after being triggered, mark the first item information as in a completed state in the first system and/or in the first topic group; the sixth control is configured to, after being triggered, mark the first item information as in a recording state in the first system and/or in the first topic group; the seventh control is configured to, after being triggered, determine content in a second system and associate the content with the first item information.

In some embodiments, as shown in FIG. 10, the first topic information in the first topic group is shown in a form of a topic card. The topic card may be a card in a predetermined data format, which sets content displayed in different areas. The topic card is displayed with the fifth control “Solved”, the sixth control “Recorded” and the seventh control “Associated with the second system” that can be triggered are displayed. The progress of the first item information can be updated through the fifth control and the sixth control. In some embodiments, “Solved” indicates that the first item information has been completed, and “Recorded” means that the first item information has been recorded, but it cannot be solved temporarily. In some embodiments, the first topic information can be associated with the content in the second system, and the seventh control can be triggered by clicking, etc., and then the first topic information is associated with the content in the second system.

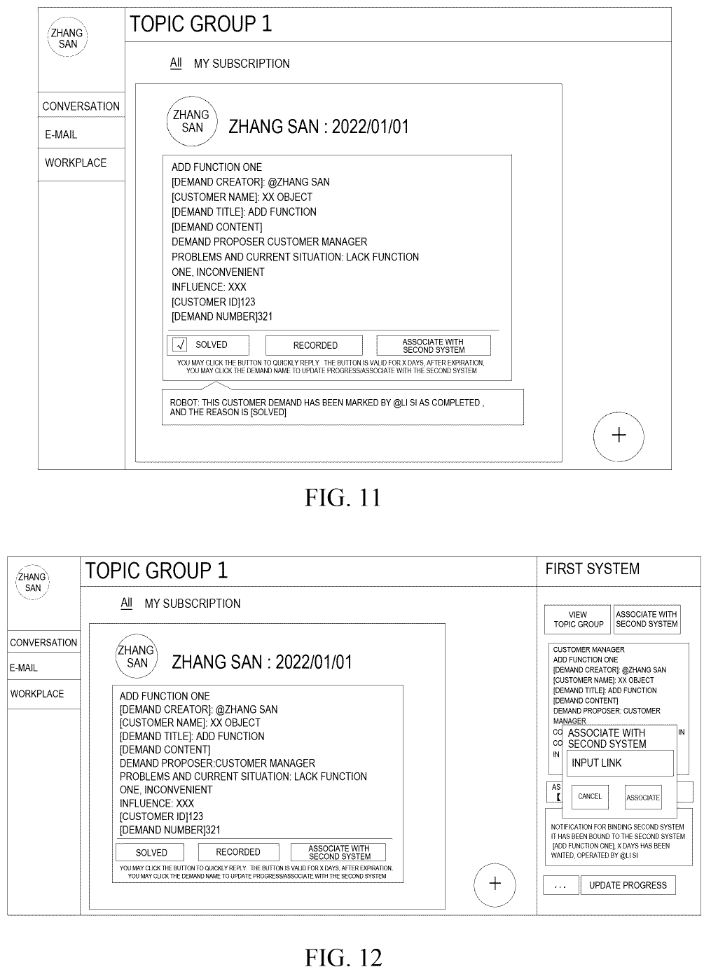

In some embodiments, after the fifth control, the sixth control or the seventh control is triggered, sending a first notification message in the first topic group in a form of replying to the first topic information, or sending the first notification message in the first topic group and mentioning the first user in the form of replying to the first topic information. In some embodiments, as shown in FIG. 11, taking the fifth control “Solved” being triggered as an example, after the fifth control is triggered, the first notification message can be sent in the form of replying messages to the first topic information. Since it is a reply to the first topic information, the first user may receive the first notification message. The first notification message can be sent through an account of a chat robot, and the first user can be reminded by mentioning him/her. The triggering user for triggering the fifth control, the sixth control or the seventh control may be mentioned in the first notification message, for example, “@LiSi” in FIG. 11. Since the triggering user is mentioned, the triggering user may receive the notification.

In some embodiments, the first item information is associated with one or more pieces of content in the second system. In some embodiments, the content in the second system may be a processing task of the first item information. For example, the first item information can be divided into a plurality of subtasks, and the plurality of subtasks has to be associated with the first item information. In some other embodiments, the content in the second system may be related item of the first item information. For example, in order to complete the first item information, task 1 needs to be completed first. Task 2 can only be processed after the first item information is completed. Then tasks 1 and 2 need to be associated with the first item information.

In some embodiments of the present disclosure, after the seventh control is triggered, displaying an address input area for inputting an address of content in the second system; if the address inputted in the address input area is wrong, displaying a prompt message; and if the address inputted in the address input area is correct, associating the first item information with the content in the second system corresponding to the input address. In some embodiments, as shown in FIG. 12, the seventh control “Associate with the second system” in the first topic information shown in FIG. 12 is triggered by clicking, etc., and then the address input area can be displayed in a pop-up window (“Input Link” area in the “Associate Second System” pop-up window shown on the right side of FIG. 12). The address is input in the address input area, and the first item information will be associated with the content in the second system corresponding to the inputted address. This method of inputting links does not require opening the second system or selecting content in the second system, which is convenient for users to operate. If the inputted address is wrong, a prompt message can be displayed. The errors of the inputted address are divided into different types. One is that no content is pointed by the address, and the other is that the permissions are insufficient and cannot be associated, and reasons of the errors can be displayed in the prompt information.

In some embodiments of the present disclosure, the method further includes: associating the first topic information with first content in a second system; and in response to update of the first content in the second system, sending second notification information to the first topic group in a form of replying to the first topic information. In some embodiments, the method also include: in response to the second notification information being triggered, opening the first content in the second system. In some embodiments, after associating the first topic information with the first content in the second system, the first topic information will be notified accordingly when the first content is updated, for example, the second notification message will be replied to the first topic information in the form of a reply message. The second system can be opened by clicking on the second notification information, etc., the location where the first content is updated can be further located, and the differences before and after the update can be displayed, so as to quickly view the update.

In some embodiments of the present disclosure, an information processing apparatus is also proposed. The information processing apparatus comprises: a determining unit configured to, in response to inputting first item information by a first user, store the first item information in a first system and determine a first topic group based on the first item information; and a sending unit configured to generate first topic information based on the first item information, and send the first topic information to the first topic group; wherein the first topic information is associated with the first item information.

In some embodiments, the information processing apparatus further comprises: a control unit configured for, in response to a first operation event for the first topic information in the first topic group, synchronizing a processing result of the first operation event to the first item information in the first system; or a control unit configured for, in response to a second operation event for the first item information in the first system, synchronizing a processing result of the second operation event to the first topic information in the first topic group.

In some embodiments, determining the first topic group based on the first item information comprises: in response to the first item information comprising a selected topic group, taking the selected topic group as the first topic group; or in response to the first item information comprising group creation information, creating the first topic group based on the group creation information.

In some embodiments, the information processing apparatus further comprises a control unit. The first item information comprising a first object, and the control unit is configured for associating the first item information with the first object in the first system.

In some embodiments, an input interface for the first item information has a first control for selecting a category of the first item information; and the first control is configured to determine whether the first item information is of a first category or a second category.

In some embodiments, in response to the first item information being of the first category, the first item information is stored in the first system and the first topic group is determined based on the first item information; and the first topic information is generated based on the first item information and the first topic information is sent to the first topic group; in response to the first item information being of the second category, the first item information is stored in the first system and a first communication group is determined based on the first item information; and first communication information is generated based on the first item information and the first communication information is sent to the first communication group, the first communication group being a non-topic group.

In some embodiments, determining the first topic group based on the first item information comprises: in response to the first item information being determined to be of the first category based on the first control, displaying at least one topic group to be selected, and in response to a selection on the at least one topic group displayed, determining a selected topic group as the first topic group; or determining the first communication group based on the first item information comprises: in response to the first item information being determined to be of the second category based on the first control, displaying a second control for creating a communication group and a selection control for selecting an existing communication group, and in response to the second control being triggered, generating communication group creation information and creating the first communication group, or in response to a selected communication group after the selection control being triggered, taking the selected communication group as the first communication group.

In some embodiments, the first topic information comprises at least one of the following determined based on the first item information: the first user, a department to which the first user belongs, a first object associated with the first item information, an identifier of the first object, a title of the first item information, an identifier of the first item information, or content of the first item information.

In some embodiments, the information processing apparatus further comprises a control unit configured for performing at least one of the following: in response to the title of the first item information or the identifier of the first item information in the first topic information being triggered, opening a details page of the first item information in the first system; in response to the first object or the identifier of the first object in the first topic information being triggered, opening a details page of the first object in the first system.

In some embodiments, sending the first topic information to the first topic group comprises at least one of the following: sending the first topic information in the first topic group by using an account of the first user; and mentioning the first user in the first topic information.

In some embodiments, the information processing apparatus further comprises a control unit configured for generating, based on the first topic information, first record information in a first document, the first record information being associated with the first topic information.

In some embodiments, the information processing apparatus further comprises a control unit. The first record information in the first document comprises an association identifier of the first topic information, and the control unit is configured for, in response to the association identifier of the first topic information in the first document being triggered, opening the first topic group and locating to the first topic information. Additionally or alternatively, the first record information in the first document comprises an association identifier of the first topic group, and the control unit is configured for, in response to the association identifier of the first topic group in the first document being triggered, opening the first topic group.

In some embodiments, the details page of the first item information in the first system is displayed with a third control, and the third control is configured to, after being triggered, locate to the first topic information in the first topic group. Additionally or alternatively, the details page of the first item information in the first system is displayed with a fourth control, and the fourth control is configured to, after being triggered, determine content in a second system and associate the content with the first item information.

In some embodiments, the first topic information is sent to the first topic group in a form of a topic card; at least one of a fifth control, a sixth control or a seventh control is displayed in the topic card of the first topic group; the fifth control is configured to, after being triggered, mark the first item information as in a completed state in the first system and/or in the first topic group; the sixth control is configured to, after being triggered, mark the first item information as in a recording state in the first system and/or in the first topic group; the seventh control is configured to, after being triggered, determine content in a second system and associate the content with the first item information.

In some embodiments, the information processing apparatus further comprises at least one of the following: after the fifth control, the sixth control or the seventh control is triggered, sending a first notification message in the first topic group in a form of replying to the first topic information, or sending the first notification message in the first topic group and mentioning the first user in the form of replying to the first topic information; the first item information being associated with one or more pieces of content in the second system; after the seventh control is triggered, displaying an address input area for inputting an address of content in the second system; if the address inputted in the address input area is wrong, displaying a prompt message; and if the address inputted in the address input area is correct, associating the first item information with the content in the second system corresponding to the input address.

In some embodiments, the information processing apparatus further comprises a control unit configured for associating the first topic information with first content in a second system.

In some embodiments, the control unit is configured for, in response to update of the first content in the second system, sending second notification information to the first topic group in a form of replying to the first topic information.

In some embodiments, the information processing apparatus further comprises a control unit configured for, in response to the second notification information being triggered, opening the first content in the second system.

For apparatus embodiments, since they basically correspond to the method embodiments, please refer to the description of the method embodiments for relevant information. The apparatus embodiments described above are only illustrative, and the modules described as separate modules may or may not be separate. Some or all of the modules may be selected according to actual needs to achieve the purpose of the solutions of this embodiment. Those skilled in the art may understand and implement the method without any creative effort.

The method and apparatus of the present disclosure have been described above based on the embodiments and application examples. In addition, the present disclosure also provides an electronic device and a computer-readable storage medium. The electronic device and computer-readable storage media are described below.

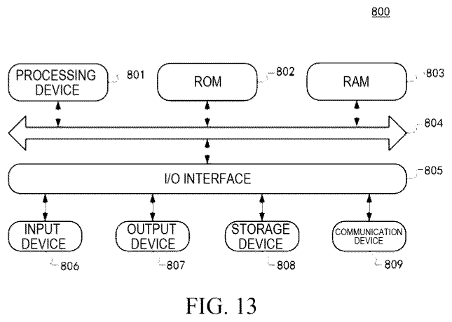

Referring to FIG. 13 below, it is a structural schematic diagram of an electronic device 800 (such as terminal device or server) suitable for implementing the embodiment of the present disclosure. The terminal device in the embodiment of the present disclosure may include but is not limited to mobile terminals such as mobile phones, laptops, digital broadcast receivers, PDAs (Personal Digital Assistants), PADs (tablet computers), PMPs (portable multimedia players), car-mounted terminals (such as car navigation terminals), etc. and fixed terminals such as digital TVs (television), desktop computers, etc. The electronic device shown in the drawings is only an example and should not bring any limitation on the functionality and scope of use of the embodiment of the present disclosure.

The electronic device 800 may include a processing device (such as a central processing unit, graphics processing unit, etc.) 801, which may perform various appropriate actions and processes based on programs stored in Read-Only Memory (ROM) 802 or loaded from storage device 808 into Random Access Memory (RAM) 803. In the RAM 803, various programs and data necessary for the operation of the electronic device 800 are also stored. The processing device 801, ROM 802, and RAM 803 are connected to each other through a bus 604. An Input/Output I/O interface 805 is also connected to the bus 804.

Typically, the following devices can be connected to I/O interface 805: input devices 806 including, for example, touch screens, touchpads, keyboards, mice, cameras, microphones, accelerometers, gyroscopes, etc.; output devices 807 including liquid crystal displays (LCDs), speakers, vibrators, etc.; storage devices 808 including magnetic tapes, hard disks, etc.; and a communication device 809. The communication device 809 may allow the electronic device 800 to communicate with other devices wirelessly or wirelessly to exchange data. Although an electronic device 800 with a plurality of devices is shown in the drawings, it shall be understood that it is not required to implement or have all of the devices shown. More or fewer devices can be implemented or provided instead.

In particular, according to embodiments of the present disclosure, the process described above with reference to the flowchart can be implemented as a computer software program. For example, an embodiment of the present disclosure includes a computer program product that includes a computer program carried on a computer-readable medium, where the computer program includes program code for performing the method shown in the flowchart. In such an embodiment, the computer program can be downloaded and installed from a network through the communication device 809, or installed from the storage device 808, or installed from the ROM 802. When the computer program is executed by the processing device 801, the above functions defined in the method of the embodiment of the present disclosure are performed.

It should be noted that the computer-readable medium described above in the present disclosure may be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. Specific examples of computer-readable storage media may include but are not limited to: an electrical connection with one or more wires, a portable computer disk, a hard disk, random access memory (RAM), read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as part of a carrier wave, which carries computer-readable program code therein. Such propagated data signals may take many forms, including but not limited to electromagnetic signals, optical signals, or any suitable combination thereof. A computer-readable signal medium may also be any computer-readable medium other than a computer-readable storage medium, which can send, propagate, or transmit programs for use by or in conjunction with instruction execution systems, apparatuses, or devices. The program code contained on the computer-readable medium may be transmitted using any suitable medium, including but not limited to: wires, optical cables, RF (radio frequency), etc., or any suitable combination thereof.

In some embodiments, clients and servers can communicate using any currently known or future developed network protocol such as HTTP (Hyper Text Transfer Protocol), and can be interconnected with any form or medium of digital data communication (such as communication networks). Examples of communication networks include local area networks (“LANs”), wide area networks (“WANs”), internetworks (such as the Internet), and end-to-end networks (such as ad hoc end-to-end networks), as well as any currently known or future developed networks.

The computer-readable medium can be included in the electronic device, or it can exist alone without being assembled into the electronic device.

The above-mentioned computer-readable medium carries one or more programs, and when the above-mentioned one or more programs are executed by the electronic device, the electronic device executes the above method of the present disclosure.

Computer program codes for performing the operations of the present disclosure may be written in one or more programming languages or a combination thereof, including Object Oriented programming languages-such as Java, Smalltalk, C++, and also conventional procedural programming languages-such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network-including local area network (LAN) or wide area network (WAN)-connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains one or more executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The units described in the embodiments of the present disclosure may be implemented by means of software or hardware, and the name of the unit does not constitute a limitation on the unit itself in a certain case.

The functions described herein above can be performed at least in part by one or more hardware logic components. For example, without limitation, exemplary types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, a machine-readable medium can be a tangible medium that may contain or store programs for use by or in conjunction with instruction execution systems, apparatuses, or devices. A machine-readable medium may be a machine-readable signal medium or a machine-readable storage medium. A machine-readable medium may include, but are not limited to, electronic, magnetic, optical, electromagnetic, infrared, or semiconductor systems, apparatuses, or devices, or any suitable combination thereof. Specific examples of the machine-readable storage medium may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

According to one or more embodiments of the present disclosure, an information processing method is provided. The method comprises: in response to inputting first item information by a first user, storing the first item information in a first system and determining a first topic group based on the first item information; and generating first topic information based on the first item information, and sending the first topic information to the first topic group; wherein the first topic information is associated with the first item information.

According to one or more embodiments of the present disclosure, an information processing method is provided. The method further comprises: in response to a first operation event for the first topic information in the first topic group, synchronizing a processing result of the first operation event to the first item information in the first system; or in response to a second operation event for the first item information in the first system, synchronizing a processing result of the second operation event to the first topic information in the first topic group.

According to one or more embodiments of the present disclosure, an information processing method is provided. Determining the first topic group based on the first item information comprises: in response to the first item information comprising a selected topic group, taking the selected topic group as the first topic group; or in response to the first item information comprising group creation information, creating the first topic group based on the group creation information.

According to one or more embodiments of the present disclosure, an information processing method is provided. The method further comprises: the first item information comprising a first object, and associating the first item information with the first object in the first system.

According to one or more embodiments of the present disclosure, an information processing method is provided. An input interface for the first item information has a first control for selecting a category of the first item information; and the first control is configured to determine whether the first item information is of a first category or a second category.

According to one or more embodiments of the present disclosure, an information processing method is provided. The method comprises: in response to the first item information being of the first category, storing the first item information in the first system and determining the first topic group based on the first item information; and generating the first topic information based on the first item information and sending the first topic information to the first topic group; in response to the first item information being of the second category, storing the first item information in the first system and determining a first communication group based on the first item information; and generating first communication information based on the first item information and sending the first communication information to the first communication group, the first communication group being a non-topic group.

According to one or more embodiments of the present disclosure, an information processing method is provided. Determining the first topic group based on the first item information comprises: in response to the first item information being determined to be of the first category based on the first control, displaying at least one topic group to be selected, and in response to a selection on the at least one topic group displayed, determining a selected topic group as the first topic group; or determining the first communication group based on the first item information comprises: in response to the first item information being determined to be of the second category based on the first control, displaying a second control for creating a communication group and a selection control for selecting an existing communication group, and in response to the second control being triggered, generating communication group creation information and creating the first communication group, or in response to a selected communication group after the selection control being triggered, taking the selected communication group as the first communication group.

According to one or more embodiments of the present disclosure, an information processing method is provided. The first topic information comprises at least one of the following determined based on the first item information: the first user, a department to which the first user belongs, a first object associated with the first item information, an identifier of the first object, a title of the first item information, an identifier of the first item information, or content of the first item information.

According to one or more embodiments of the present disclosure, an information processing method is provided. The method further comprises at least one of the following: in response to the title of the first item information or the identifier of the first item information in the first topic information being triggered, opening a details page of the first item information in the first system; in response to the first object or the identifier of the first object in the first topic information being triggered, opening a details page of the first object in the first system.

According to one or more embodiments of the present disclosure, an information processing method is provided. Transmitting the first topic information to the first topic group comprises at least one of the following: sending the first topic information in the first topic group by using an account of the first user; and mentioning the first user in the first topic information.

According to one or more embodiments of the present disclosure, an information processing method is provided. The method further comprises: generating, based on the first topic information, first record information in a first document, the first record information being associated with the first topic information.

According to one or more embodiments of the present disclosure, an information processing method is provided. The method further comprises: the first record information in the first document comprises an association identifier of the first topic information; in response to the association identifier of the first topic information in the first document being triggered, opening the first topic group and locating to the first topic information; and/or, the first record information in the first document comprises an association identifier of the first topic group; in response to the association identifier of the first topic group in the first document being triggered, opening the first topic group.

According to one or more embodiments of the present disclosure, an information processing method is provided. The details page of the first item information in the first system is displayed with a third control, and the third control is configured to, after being triggered, locate to the first topic information in the first topic group. Additionally or alternatively, the details page of the first item information in the first system is displayed with a fourth control, and the fourth control is configured to, after being triggered, determine content in a second system and associate the content with the first item information.

According to one or more embodiments of the present disclosure, an information processing method is provided. The first topic information is sent to the first topic group in a form of a topic card; at least one of a fifth control, a sixth control or a seventh control is displayed in the topic card of the first topic group. The fifth control is configured to, after being triggered, mark the first item information as in a completed state in the first system and/or in the first topic group. The sixth control is configured to, after being triggered, mark the first item information as in a recording state in the first system and/or in the first topic group. The seventh control is configured to, after being triggered, determine content in a second system and associate the content with the first item information.

According to one or more embodiments of the present disclosure, an information processing method is provided. The method further comprises at least one of the following: after the fifth control, the sixth control or the seventh control is triggered, sending a first notification message in the first topic group in a form of replying to the first topic information, or sending the first notification message in the first topic group and mentioning the first user in the form of replying to the first topic information; the first item information being associated with one or more pieces of content in the second system; after the seventh control is triggered, displaying an address input area for inputting an address of content in the second system; if the address inputted in the address input area is wrong, displaying a prompt message; and if the address inputted in the address input area is correct, associating the first item information with the content in the second system corresponding to the input address.

According to one or more embodiments of the present disclosure, an information processing method is provided. The method further comprises associating the first topic information with first content in a second system; in response to update of the first content in the second system, sending second notification information to the first topic group in a form of replying to the first topic information.

According to one or more embodiments of the present disclosure, an information processing method is provided. The method further comprises: in response to the second notification information being triggered, opening the first content in the second system.

According to one or more embodiments of the present disclosure, an information processing apparatus is provided. The information processing apparatus comprises: a determining unit configured to, in response to inputting first item information by a first user, store the first item information in a first system and determine a first topic group based on the first item information; and a sending unit configured to generate first topic information based on the first item information, and send the first topic information to the first topic group; wherein the first topic information is associated with the first item information.

According to one or more embodiments of the present disclosure, an electronic device is provided. The electronic device comprises at least one memory and at least one processor; wherein the at least one memory is configured to store program code, and the at least one processor is configured to call the program code stored in the at least one memory to execute any of the above-described method.

According to one or more embodiments of the present disclosure, a computer-readable storage medium is provided, wherein the computer-readable storage medium is configured to store program code, when run by a processor, the program code causes the processor to execute the above-described method.

The above description is only embodiments of this disclosure and an explanation of the technical principles used. Those skilled in the art should understand that the scope of the disclosure involved in this disclosure is not limited to technical solutions composed of specific combinations of the above technical features, but should also covers other technical solutions formed by arbitrary combinations of the above technical features or their equivalent features without departing from the above disclosure concept. For example, technical solutions formed by replacing the above features with (but not limited to) technical features with similar functions disclosed in this disclosure.

In addition, although multiple operations are depicted in a specific order, this should not be understood as requiring these operations to be performed in the specific order shown or in a sequential order. In certain environments, multitasking and parallel processing may be advantageous. Similarly, although multiple implementation details are included in the above discussion, these should not be construed as limiting the scope of the present disclosure. Some features described in the context of individual embodiments can also be implemented in combination in a single embodiment. Conversely, multiple features described in the context of a single embodiment can also be implemented in multiple embodiments separately or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

I/We claim:

1. An information processing method, comprising:
in response to inputting first item information by a first user, storing the first item information in a first system and determining a first topic group based on the first item information; and
generating first topic information based on the first item information, and sending the first topic information to the first topic group;
wherein the first topic information is associated with the first item information.

2. The method of claim 1, further comprising:
in response to a first operation event for the first topic information in the first topic group, synchronizing a processing result of the first operation event to the first item information in the first system; or
in response to a second operation event for the first item information in the first system, synchronizing a processing result of the second operation event to the first topic information in the first topic group.

3. The method of claim 1, wherein determining the first topic group based on the first item information comprises:
in response to the first item information comprising a selected topic group, taking the selected topic group as the first topic group; or
in response to the first item information comprising group creation information, creating the first topic group based on the group creation information.

4. The method of claim 1, further comprising:
the first item information comprising a first object, and associating the first item information with the first object in the first system.

5. The method of claim 1, wherein an input interface for the first item information has a first control for selecting a category of the first item information; and the first control is configured to determine whether the first item information is of a first category or a second category.

6. The method of claim 5, further comprising:
in response to the first item information being of the first category, storing the first item information in the first system and determining the first topic group based on the first item information; and generating the first topic information based on the first item information and sending the first topic information to the first topic group;
in response to the first item information being of the second category, storing the first item information in the first system and determining a first communication group based on the first item information; and generating first communication information based on the first item information and sending the first communication information to the first communication group, the first communication group being a non-topic group.

7. The method of claim 6, wherein,
determining the first topic group based on the first item information comprises: in response to the first item information being determined to be of the first category based on the first control, displaying at least one topic group to be selected, and in response to a selection on the at least one topic group displayed, determining a selected topic group as the first topic group: or
determining the first communication group based on the first item information comprises: in response to the first item information being determined to be of the second category based on the first control, displaying a second control for creating a communication group and a selection control for selecting an existing communication group, and in response to the second control being triggered, generating communication group creation information and creating the first communication group, or in response to a selected communication group after the selection control being triggered, taking the selected communication group as the first communication group.

8. The method of claim 1, wherein the first topic information comprises at least one of the following determined based on the first item information: the first user, a department to which the first user belongs, a first object associated with the first item information, an identifier of the first object, a title of the first item information, an identifier of the first item information, or content of the first item information.

9. The method of claim 8, further comprising at least one of the following:
in response to the title of the first item information or the identifier of the first item information in the first topic information being triggered, opening a details page of the first item information in the first system;
in response to the first object or the identifier of the first object in the first topic information being triggered, opening a details page of the first object in the first system.

10. The method of claim 1, wherein sending the first topic information to the first topic group comprises at least one of the following:
sending the first topic information in the first topic group by using an account of the first user; and
mentioning the first user in the first topic information.

11. The method of claim 1, further comprising:
generating, based on the first topic information, first record information in a first document, the first record information being associated with the first topic information.

12. The method of claim 11, further comprising:
the first record information in the first document comprises an association identifier of the first topic information: in response to the association identifier of the first topic information in the first document being triggered, opening the first topic group and locating to the first topic information; and/or,
the first record information in the first document comprises an association identifier of the first topic group; in response to the association identifier of the first topic group in the first document being triggered, opening the first topic group.

13. The method of claim 1, wherein the details page of the first item information in the first system is displayed with a third control, and the third control is configured to, after being triggered, locate to the first topic information in the first topic group; and/or
the details page of the first item information in the first system is displayed with a fourth control, and the fourth control is configured to, after being triggered, determine content in a second system and associate the content with the first item information.

14. The method of claim 1, wherein
the first topic information is sent to the first topic group in a form of a topic card: at least one of a fifth control, a sixth control or a seventh control is displayed in the topic card of the first topic group;
the fifth control is configured to, after being triggered, mark the first item information as in a completed state in the first system and/or in the first topic group;
the sixth control is configured to, after being triggered, mark the first item information as in a recording state in the first system and/or in the first topic group;
the seventh control is configured to, after being triggered, determine content in a second system and associate the content with the first item information.

15. The method of claim 14, further comprising at least one of the following:
after the fifth control, the sixth control or the seventh control is triggered, sending a first notification message in the first topic group in a form of replying to the first topic information, or sending the first notification message in the first topic group and mentioning the first user in the form of replying to the first topic information;
the first item information being associated with one or more pieces of content in the second system;
after the seventh control is triggered, displaying an address input area for inputting an address of content in the second system: if the address inputted in the address input area is wrong, displaying a prompt message; and if the address inputted in the address input area is correct, associating the first item information with the content in the second system corresponding to the input address.

16. The method of claim 1, further comprising:
associating the first topic information with first content in a second system;
in response to update of the first content in the second system, sending second notification information to the first topic group in a form of replying to the first topic information.

17. The method of claim 16, further comprising:
in response to the second notification information being triggered, opening the first content in the second system.

18. An electronic device, comprising:
at least one memory and at least one processor;
wherein the at least one memory is configured to store program code, and the at least one processor is configured to call the program code stored in the at least one memory to perform acts comprising:
in response to inputting first item information by a first user, storing the first item information in a first system and determining a first topic group based on the first item information; and
generating first topic information based on the first item information, and sending the first topic information to the first topic group;
wherein the first topic information is associated with the first item information.

19. The electronic device of claim 18, wherein the acts further comprises:
in response to a first operation event for the first topic information in the first topic group, synchronizing a processing result of the first operation event to the first item information in the first system; or
in response to a second operation event for the first item information in the first system, synchronizing a processing result of the second operation event to the first topic information in the first topic group.

20. A non-transitory computer-readable storage medium, wherein the computer-readable storage medium is configured to store program code, when run by a processor, the program code causes the processor to perform acts comprising:
in response to inputting first item information by a first user, storing the first item information in a first system and determining a first topic group based on the first item information; and
generating first topic information based on the first item information, and sending the first topic information to the first topic group;
wherein the first topic information is associated with the first item information.
